(19) United States
(12) Patent Application Publication
(10) Pub. No.: US 2023/0102945 A1
(43) Pub. Date: Mar. 30, 2023

(54) OPTICAL UNIT

(71) Applicant: Nidec Corporation, Kyoto (JP)

(72) Inventors: Kazuhiro SAZAI, Kyoto (JP); Keishi OTSUBO, Kyoto (JP)

(21) Appl. No.: 17/948,273

(22) Filed: Sep. 20, 2022

(30) Foreign Application Priority Data
Sep. 29, 2021 (JP) 2021-159279

(51) Int. Cl. G02B 7/02; H01F 7/02

(52) U.S. Cl. CPC G02B 7/02; H01F 7/02

(57) ABSTRACT

An optical assembly includes a movable body including an optical element, a fixed body that is located around the movable body and swingably supports the movable body, and a swing mechanism that causes the movable body to swing about a swing axis with respect to the fixed body. The swing mechanism is located in a first direction orthogonal to the swing axis, and the swing mechanism includes a magnet on the movable body and a coil on the fixed body. The fixed body includes a circuit board that is located on one side in the first direction of the fixed body and electrically connected to the coil, a reinforcing plate that is on the circuit board and includes a depression depressed toward another side in the first direction, and a magnetic body that is located in the depression and at least partially overlaps the magnet.

### CROSS-REFERENCE TO RELATED APPLICATIONS

The present application claims priority under 35 U.S.C. § 119 to Japanese Patent Application No. 2021-159279, filed on Sep. 29, 2021, the entire contents of which are hereby incorporated herein by reference.

### 1. FIELD OF THE INVENTION

The present disclosure relates to an optical assembly.

### 2. BACKGROUND

Sometimes an image blur is generated due to camera shake during capturing a still image or moving image with a camera. For this reason, an image stabilization device has been put into practical use to enable clear imaging with image blur prevention. When the camera shakes, the image stabilization device can remove the image blur by correcting a position and orientation of a camera module according to the shake.

In order to downsize a lens driving device having an image stabilization function, it has been considered to design some of multiple rolling members supporting a shake correction unit with a higher degree of freedom than other rolling members. In a conventional lens driving device, a yoke (magnetic body) is disposed at a position facing a magnet for swing, so that attractive force acts between the yoke and the magnet in a direction perpendicular to an optical axis (Z-axis), and the rolling member maintains a contact state between a carrier and a housing.

In the conventional lens driving device, an attachment position of the yoke may deviate from an original position, and there is a possibility that the direction of the attractive force acting between the yoke and the magnet may deviate from the original direction.

### SUMMARY

An optical assembly according to an example embodiment of the present disclosure includes a movable body including an optical element, a fixed body that is located around the movable body and swingably supports the movable body, and a swing mechanism that causes the movable body to swing about a swing axis with respect to the fixed body. The swing mechanism is located in a first direction orthogonal to the swing axis, and the swing mechanism includes a magnet located on the movable body and a coil located on the fixed body. The fixed body includes a circuit board that is on one side in the first direction of the fixed body and electrically connected to the coil, a reinforcing plate that is located on the circuit board and includes a depression depressed toward another side in the first direction, and a magnetic body that is located in the depression and at least partially overlaps the magnet as viewed from the first direction. The depression includes a peripheral surface perpendicular to the first direction, and the magnetic body is in contact with the peripheral surface of the depression in at least two locations.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic perspective view illustrating a smartphone including an optical assembly according to an example embodiment of the present disclosure.

FIG. 2 is a schematic perspective view illustrating an optical assembly according to an example embodiment of the present disclosure.

FIG. 3 is a schematic perspective view illustrating a first swing mechanism, a magnet, and a first magnetic body in an optical assembly according to an example embodiment of the present disclosure.

FIG. 4A is a schematic side view illustrating an optical assembly according to an example embodiment of the present disclosure.

FIG. 4B is a partially enlarged view of a sectional view taken along an X-axis in FIG. 2.

FIG. 5A is a schematic side view illustrating a reinforcing plate of an optical assembly according to an example embodiment of the present disclosure.

FIG. 5B is a schematic side view after a magnetic body is installed on a reinforcing plate of an optical assembly according to an example embodiment of the present disclosure.

FIG. 5C is a schematic side view illustrating a reinforcing plate of an optical assembly according to an example embodiment of the present disclosure.

FIG. 5D is a schematic side view illustrating a reinforcing plate of an optical assembly according to an example embodiment of the present disclosure.

FIG. 5E is a schematic top view illustrating a reinforcing plate of an optical assembly according to an example embodiment of the present disclosure.

FIG. 5F is a schematic top view when a magnetic body is installed on a reinforcing plate of an optical assembly according to an example embodiment of the present disclosure.

FIG. 5G is a schematic top view after a magnetic body is installed on a reinforcing plate of an optical assembly according to an example embodiment of the present disclosure.

FIG. 6A is a schematic side view of an optical assembly according to an example embodiment of the present disclosure.

FIG. 6B is a partially enlarged view of a sectional view taken along an X-axis of an optical assembly according to an example embodiment of the present disclosure.

FIG. 7A is a schematic side view of an optical assembly according to an example embodiment of the present disclosure.

FIG. 7B is a partially enlarged view of a sectional view taken along the X-axis of an optical assembly according to an example embodiment of the present disclosure.

FIG. 8A is a schematic side view of an optical assembly according to an example embodiment of the present disclosure.

FIG. 8B is a schematic side view illustrating a reinforcing plate of an optical assembly according to an example embodiment of the present disclosure.

FIG. 9 is a schematic exploded perspective view illustrating an optical assembly according to an example embodiment of the present disclosure.

FIG. 10 is a schematic perspective view illustrating a first swing mechanism, a magnet, and a first magnetic body of an optical assembly according to an example embodiment of the present disclosure.

FIG. 11 is a schematic side view of an optical assembly according to an example embodiment of the present disclosure.

FIG. 12 is a schematic perspective view illustrating a first swing mechanism, a second swing mechanism, a magnet, a first magnetic body, a second magnetic body, and a third magnetic body an optical assembly according to an example embodiment of the present disclosure.

FIG. 13 is a schematic perspective view illustrating a first swing mechanism, a second swing mechanism, a magnet, a first magnetic body, a second magnetic body, a third magnetic body, and a fourth magnetic body an optical assembly according to an example embodiment of the present disclosure.

FIG. 14 is a schematic perspective view illustrating a first swing mechanism, a second swing mechanism, a third swing mechanism, a magnet, a first magnetic body, a second magnetic body, a third magnetic body, and a fourth magnetic body of an optical assembly according to an example embodiment of the present disclosure.

FIG. 15 is a schematic side view of an optical assembly according to an example embodiment of the present disclosure.

FIG. 16 is a schematic exploded perspective view illustrating an optical assembly according to an example embodiment of the present disclosure.

FIG. 17A is a schematic side view illustrating a first magnetic body of an optical assembly according to an example embodiment of the present disclosure.

FIG. 17B is a schematic side view of an optical assembly according to an example embodiment of the present disclosure.

FIG. 17C is a schematic side view of an optical assembly according to an example embodiment of the present disclosure.

FIG. 18 is a schematic side view of an optical assembly according to an example embodiment of the present disclosure.

### DETAILED DESCRIPTION

Hereinafter, optical assemblies according to example embodiments of the present disclosure will be described with reference to the drawings. In the drawings, the same or corresponding parts will be denoted by the same reference symbols and description of such parts will not be repeated. In the description of the present application, an X-axis, a Y-axis, and a Z-axis that are orthogonal to one another may be used to facilitate understanding of example embodiments of the present disclosure. Here, it should be noted that the X-axis, the Y-axis, and the Z-axis do not limit the orientation of the optical assembly during use. In addition, expressions regarding directions such as “parallel”, “vertical”, and “orthogonal” in the present specification are not limited to geometrically strict directions. It may be inclined from the geometrically strict direction to such an extent that the effect of the invention is exhibited.

An optical assembly 100 is suitably used as an optical component of a smartphone.

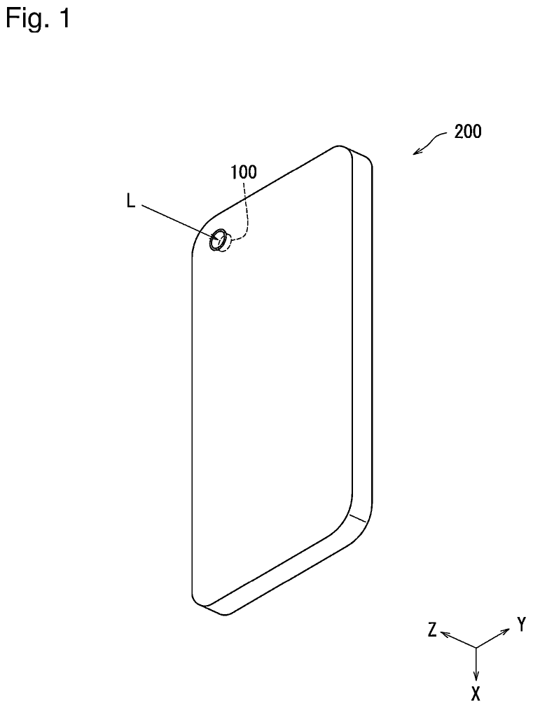

First, with reference to FIG. 1, a smartphone 200 including the optical assembly 100 of the example embodiment of the present disclosure will be described. FIG. 1 is a schematic perspective view illustrating the smartphone 200 including the optical assembly 100 of the example embodiment of the present disclosure.

As illustrated in FIG. 1, the optical assembly 100 is incorporated in the smartphone 200 as an example. Light L enters the smartphone 200 from an outside through the optical assembly 100, and a subject image is captured based on the light that enters the optical assembly 100. The optical assembly 100 is used to correct blur of the captured image when the smartphone 200 shakes. The optical assembly 100 may include an imaging element, and the optical assembly 100 may include an optical member that transmits the light to the imaging element.

The optical assembly 100 is preferably manufactured in a small size. Thus, the smartphone 200 itself can be downsized, or another component can be incorporated in the smartphone 200 without upsizing the smartphone 200.

The application of the optical assembly 100 is not limited to the smartphone 200, but the optical assembly 100 can be used in various devices such as a camera and a video without particular limitation. For example, the optical assembly 100 may be incorporated in an imaging device such as a mobile phone with a camera or a drive recorder, or an action camera and a wearable camera incorporated in a moving body such as a helmet, a bicycle, or a radio-controlled helicopter.

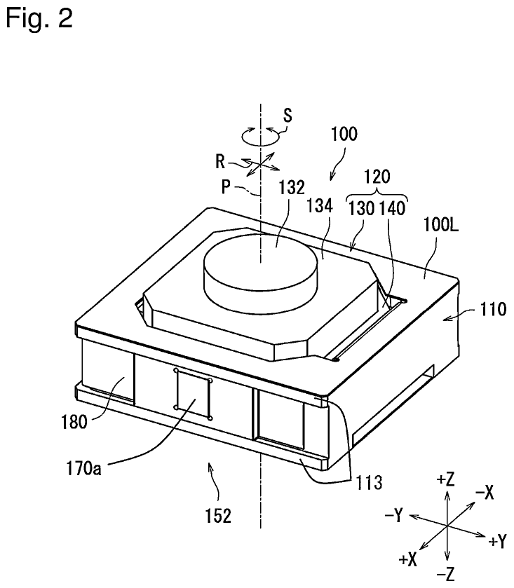

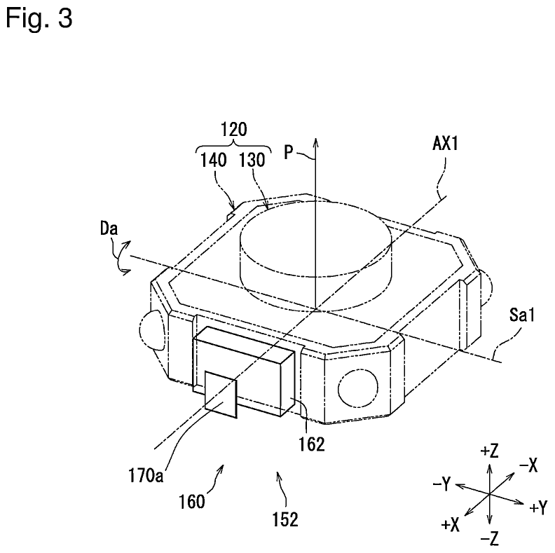

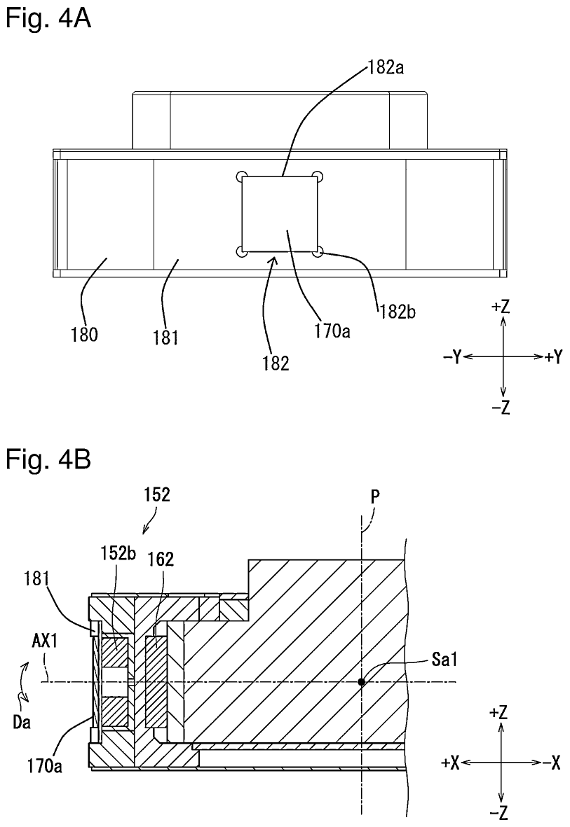

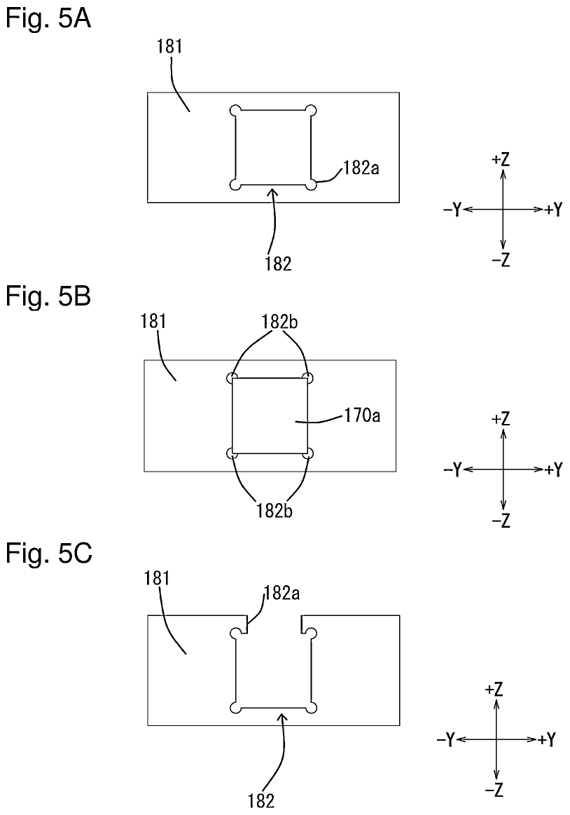

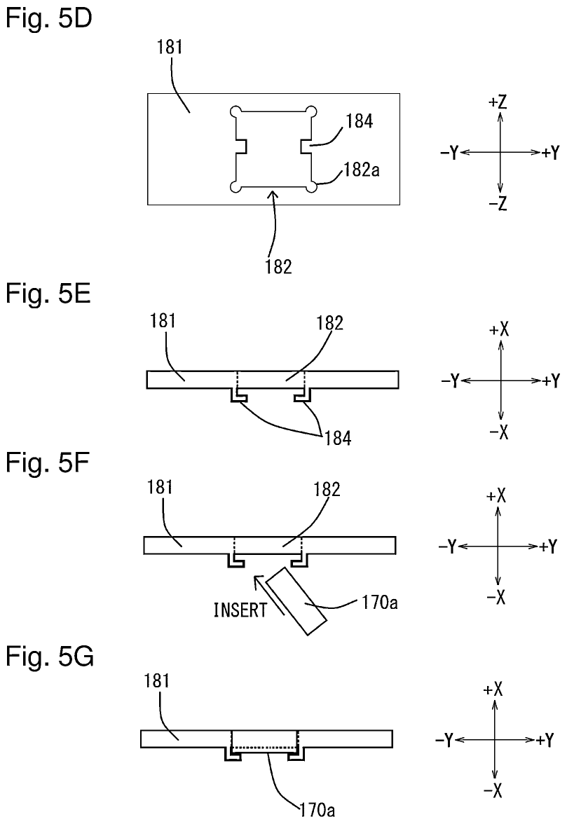

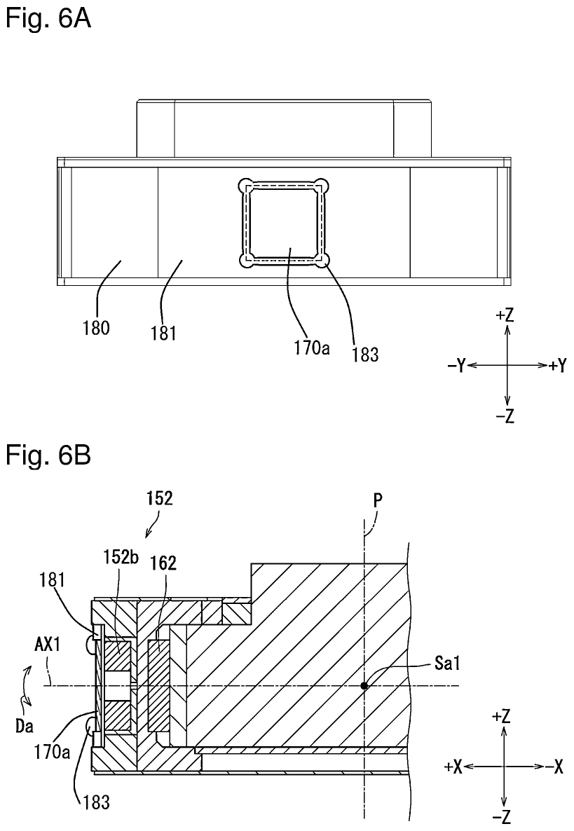

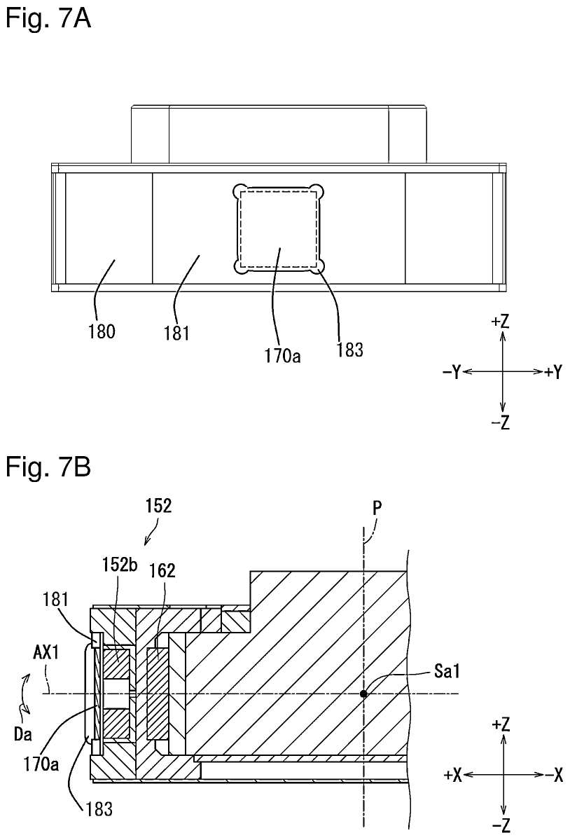

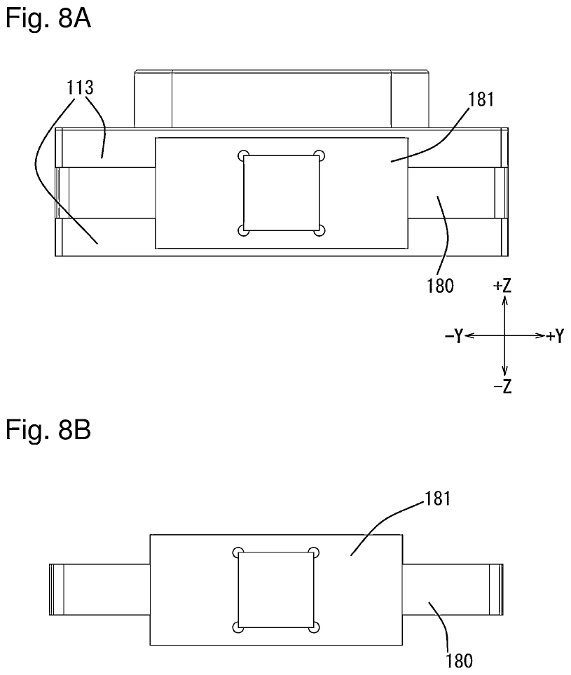

With reference to FIGS. 2 to 9, a configuration of the optical assembly 100 of the example embodiment of the present disclosure will be described below. FIG. 2 is a schematic perspective view illustrating the optical assembly 100 of the example embodiment of the present disclosure. FIG. 3 is a schematic perspective view illustrating a first swing mechanism 152, a magnet 160, and a first magnetic body 170a in the optical assembly 100 of the example embodiment of the present disclosure; In FIG. 3, a movable body 120 is indicated by a two-dot chain line for reference. FIG. 4A is a schematic side view illustrating the optical assembly of the example embodiment of the present disclosure. FIG. 4B is a partially enlarged view of a sectional view taken along the X-axis in FIG. 2. FIG. 5A is a schematic side view illustrating a reinforcing plate 181 alone of the example embodiment of the present disclosure. FIG. 5B is a schematic side view after a magnetic body is installed on a reinforcing plate 181 of the example embodiment of the present disclosure. FIG. 5C is a schematic side view illustrating the reinforcing plate 181 alone of the example embodiment of the present disclosure. FIG. 5D is a schematic side view illustrating the reinforcing plate alone of the example embodiment of the present disclosure. FIG. 5E is a schematic top view illustrating the reinforcing plate alone of the example embodiment of the present disclosure. FIG. 5F is a schematic top view when the magnetic body is installed on the reinforcing plate of the example embodiment of the present disclosure. FIG. 5G is a schematic top view after the magnetic body is installed on the reinforcing plate of the example embodiment of the present disclosure. FIG. 6A is a schematic side view in the example embodiment of the present disclosure. FIG. 6B is a partially enlarged view of a sectional view taken along an X-axis of the example embodiment of the present disclosure. FIG. 7A is a schematic side view in the example embodiment of the present disclosure. FIG. 7B is a partially enlarged view of a sectional view taken along the X-axis of the example embodiment of the present disclosure. FIG. 8A is a schematic side view in the example embodiment of the present disclosure. FIG. 8B is a schematic side view illustrating the reinforcing plate 181 alone of the example embodiment of the present disclosure.

As illustrated in FIGS. 2 and 3, the optical assembly 100 includes a fixed body 110, the movable body 120, and the first swing mechanism 152. The movable body 120 includes an optical element 130. The movable body 120 is inserted into the fixed body 110 and held by the fixed body 110. The fixed body 110 is located around the movable body 120. The fixed body 110 supports the movable body 120 so as to be swingable in a first swing direction Da about a first swing axis Sa1. The first swing direction Da is a direction in which the movable body 120 swings with respect to the fixed body 110 about the first swing axis Sa1. The first swing axis Sa1 is a virtual axis. An FPC 180 is mounted on an outer surface of the fixed body 110.

The first swing mechanism 152 swings the movable body 120 with respect to the fixed body 110. The first swing mechanism 152 swings the movable body 120 with respect to the fixed body 110 about the first swing axis Sa1. For example, the first swing axis Sa1 extends parallel to the Y-axis direction. At this point, the first swing mechanism 152 is located on a +X-direction side of the movable body 120.

The optical assembly 100 may further include a lid 100L. The lid 100L covers one side of each of the fixed body 110 and the movable body 120, so that detachment of the movable body 120 from the fixed body 110 can be prevented.

The movable body 120 includes the optical element 130 and a holder 140. The optical element 130 has an optical axis P. The optical element 130 can be inserted into the holder 140.

When the movable body 120 is inserted into the fixed body 110 to mount the movable body 120 on the fixed body 110, the optical axis P of the optical element 130 becomes parallel to the Z-axis direction. When the movable body 120 swings with respect to the fixed body 110 from this state, the optical axis P of the optical element 130 swings, so that the optical axis P is no longer parallel to the Z-axis direction.

In the following description, it is assumed that the movable body 120 is not swung with respect to the fixed body 110 and that the state in which the optical axis P is parallel to the Z-axis direction is maintained. That is, in the description of shapes, positional relationships, operations, and the like of the fixed body 110, the movable body 120, the lid 100L, and the like with reference to the optical axis P, it is assumed that the optical axis P is parallel to the Z-axis direction unless the inclination of the optical axis P is specifically described.

The first swing mechanism 152 swings the movable body 120 with respect to the fixed body 110 about the first swing axis Sa1. At this point, the first swing axis Sa1 is parallel to the Y-axis direction. The Y-axis direction is a direction intersecting with the optical axis P, and is an axis of rotation in a yawing direction. Typically, the first swing axis Sa1 is orthogonal to the optical axis P.

As described later in the present specification, a swing mechanism other than the first swing mechanism 152 may swing the movable body 120 with respect to the fixed body 110 about the X-axis direction or the Z-axis direction. The X-axis direction is a direction orthogonal to the optical axis P, and is an axis of rotation in a pitching direction. The Z-axis direction is parallel to the optical axis direction in which the optical axis P of the optical element 130 extends, and is an axis of rotation in a rolling direction.

In an optical instrument including the optical element 130, when the optical instrument is inclined at the time of imaging, the optical element 130 is inclined, and the captured image is disturbed. In order to avoid disturbance of the captured image, the optical assembly 100 corrects the inclination of the optical element 130 based on acceleration, an angular velocity, a shake amount, and the like detected by detection means such as a gyroscope. In the example embodiment, the optical assembly 100 corrects the inclination of the optical element 130 by swinging (rotating) the movable body 120 in a rotation direction (yawing direction) with the Y-axis as the rotation axis. In addition to the yawing direction, the optical assembly 100 may correct the inclination of the optical element 130 by swinging (rotating) the movable body 120 in a rotation direction (pitching direction) with the X-axis as the rotation axis and in a rotation direction (rolling direction) with the Z-axis as the rotation axis.

The optical axis P of the optical element 130 is parallel to a normal line of a light incident surface of the optical element 130. The light from the optical axis P enters the optical element 130.

The optical element 130 includes a lens 132 and a housing 134. The optical element 130 may include an image sensor in the housing 134. The optical element 130 including the image sensor is also called a camera module. When the optical element 130 is inserted into the holder 140, the optical element 130 is held by the holder 140.

The holder 140 has an annular shape in which both ends in the Z-axis direction are open. The optical element 130 is attached to the inside of the holder 140.

The holder 140 is a thick plate-shaped frame body extending in a direction orthogonal to the optical axis P. The direction orthogonal to the optical axis P is a direction that intersects with the optical axis P and is perpendicular to the optical axis P. In the present specification, sometimes the direction orthogonal to the optical axis P is referred to as a “radial direction”. A radial outside indicates a direction separating from the optical axis P. In FIG. 2, a reference sign R indicates an example of the radial direction. Sometimes a direction of rotation about the optical axis P is referred to as a “circumferential direction”. In FIG. 2, a reference sign S indicates the circumferential direction.

The optical assembly 100 of the example embodiment of the present disclosure further includes a magnet 160. The magnet 160 includes a first magnet 162. The first magnet 162 is located on the +X-direction side with respect to the movable body 120 and extends in the Y-axis direction.

As illustrated in FIGS. 4A and 4B, the optical assembly 100 further includes a first magnetic body 170a. The first magnetic body 170a is attached to the fixed body 110. For example, the first magnetic body 170a is a rectangular plate member. In the example embodiment of the present disclosure, the first magnetic body 170a has a square shape. As described later, the first magnetic body 170a may be configured by arranging a plurality of magnetic bodies.

The first magnetic body 170a passes through an axis AX1 perpendicular to each of the first swing axis Sa1 and the optical axis P of the optical element 130. The first magnetic body 170a faces the first magnet 162. Accordingly, the movable body 120 can be held at an initial position. The initial position indicates a position, where the movable body 120 is not swung with respect to the fixed body 110 and a state in which the optical axis P is parallel to the Z-axis direction is maintained.

The optical assembly 100 further includes a reinforcing plate 181. The reinforcing plate 181 is disposed on the FPC 180. That is, in FIGS. 4A and 4B, the FPC 180 is disposed on the +X-direction side with respect to the fixed body 110, and the reinforcing plate 181 is further disposed on the +X-direction side with respect to the FPC 180. Further, the reinforcing plate 181 has a depression 182. The depression 182 is depressed in the direction toward the FPC 180, namely, toward the −X-direction side. The depression 182 includes a peripheral surface 182a expanding on a YZ-plane perpendicular to the X-direction. The first magnetic body 170a is disposed in the depression. The first magnetic body 170a is in contact with the peripheral surface 182a of the depression 182 at two or more locations.

With the above configuration, the first magnetic body 170a can be positioned in the depression 182. Accordingly, the magnetic body is easily installed at a predetermined position on the fixed body. Thus, a yield of the optical assembly 100 can be improved.

The position of the first magnet 162 with respect to the movable body 120 and the position of the first magnetic body 170a with respect to the fixed body 110 are not limited to the +X-direction side. For example, when the position of the first magnet 162 with respect to the movable body 120 and the position of the first magnetic body 170a with respect to the fixed body 110 are located the −X-direction side, the FPC 180 is disposed on the −X-direction side with respect to the fixed body 110. The reinforcing plate 181 is further disposed on the −X-direction side with respect to the FPC 180. In this case, the depression 182 is recessed in the direction toward the FPC 180, namely, toward the +X-direction side. In this case, the depression 182 includes the peripheral surface 182a expanding on the YZ-plane perpendicular to the X direction. The first magnetic body 170a is in contact with the peripheral surface 182a of the depression 182 at two or more locations.

For example, when the position of the first magnet 162 with respect to the movable body 120 and the position of the first magnetic body 170a with respect to the fixed body 110 are located on the +Y-direction side, the FPC 180 is disposed on the +Y-direction side with respect to the fixed body 110. The reinforcing plate 181 is further disposed on the +Y-direction side with respect to the FPC 180. In this case, the depression 182 is recessed in the direction toward the FPC 180, namely, toward the −Y-direction side. In this case, the depression 182 includes the peripheral surface 182a expanding on an XZ-plane perpendicular to the Y-direction. The first magnetic body 170a is in contact with the peripheral surface 182a of the depression 182 at two or more locations.

For example, when the position of the first magnet 162 with respect to the movable body 120 and the position of the first magnetic body 170a with respect to the fixed body 110 are located on the −Y-direction side, the FPC 180 is disposed on the −Y-direction side with respect to the fixed body 110. The reinforcing plate 181 is further disposed on the −Y-direction side with respect to the FPC 180. In this case, the depression 182 is recessed in the direction toward the FPC 180, namely, toward the +Y-direction side. In this case, the depression 182 includes the peripheral surface 182a expanding on an XZ-plane perpendicular to the Y-direction. The first magnetic body 170a is in contact with the peripheral surface 182a of the depression 182 at two or more locations.

The case where the position of the first magnet 162 with respect to the movable body 120 and the position of the first magnetic body 170a with respect to the fixed body 110 are located on the +X-direction side will be described as an example in the following description. At this point, the FPC 180 is disposed on the +X-direction side with respect to the fixed body 110, and the reinforcing plate 181 is further disposed on the +X-direction side with respect to the FPC 180. When the position of the first magnet 162 with respect to the movable body 120 and the position of the first magnetic body 170a with respect to the fixed body 110 are not located on the +X-direction side, the same effect can be obtained by the reinforcing plate 181. In addition, also in the case where the fixed body 110 described later includes a plurality of magnets and a plurality of magnetic bodies, the reinforcing plate 181 can obtain the same effect for each surface.

The depression 182 may be a through-hole penetrating the reinforcing plate 181 in the X-direction. In FIGS. 4A and 4B, the first magnetic body 170a is in contact with the peripheral surface 182a of the depression 182 at two or more locations, and the first magnetic body 170a is in contact with the FPC 180 in the X-direction.

With the above configuration, a distance between the first magnetic body 170a and the first magnet 162 can be further reduced. Therefore, magnetic attraction force acting between the first magnetic body 170a and the first magnet 162 can be strengthened. As a result, the movable body 120 can be more stably held at the initial position.

The depression 182 may not be a through-hole penetrating the reinforcing plate 181 or a notch penetrating the reinforcing plate 181. For example, the depression 182 may be a depression including a bottom surface. In this case, the first magnetic body 170a is in contact with the peripheral surface 182a of the depression 182 at two or more locations, and the first magnetic body 170a is in contact with the bottom surface of the depression 182 also in the X-direction.

As illustrated in FIGS. 5A and 5B, the depression 182 may be a closed space located in the reinforcing plate 181 when viewed from the X-direction. That is, when viewed from the X-direction, an outer peripheral surface of the reinforcing plate 181 and the peripheral surface 182a of the depression 182 are independent from each other, and the peripheral surface 182a of the depression 182 is located inside the outer peripheral surface of the reinforcing plate 181.

With the above configuration, rigidity of the reinforcing plate 181 can be enhanced. This can reduce a possibility of deformation of the reinforcing plate 181. In addition, the rigidity of the FPC 180 to which the reinforcing plate 181 is attached can be enhanced. Thus, ease of handling of the FPC 180 during assembling the optical assembly 100, such as improving workability of work of attaching the FPC 180 to the fixed body 110 together with the reinforcing plate 181 after attaching the reinforcing plate 181 to the FPC 180, can be improved.

As illustrated in FIG. 5C, the depression 182 may not be a closed space located in the reinforcing plate 181, but may be a notch opened in the Z-direction or the Y-direction. That is, when viewed from the X-direction, the outer peripheral surface of the reinforcing plate 181 and the peripheral surface 182a of the depression 182 may be connected to each other.

The reinforcing plate 181 is typically obtained by punching one plate material by press working or the like. In the above configuration, more reinforcing plates 181 can be punched out from one plate material as compared with the case where the depression 182 is the closed space located in the reinforcing plate 181.

As illustrated in FIGS. 5D and 5E, the reinforcing plate 181 may have a hook 184 that overlaps the depression 182 when viewed from the X-direction.

At this time, as illustrated in FIG. 5F, the first magnetic body 170a is inserted into the depression 182 in the direction perpendicular to the thickness direction of the first magnetic body 170a.

At this point, as illustrated in FIG. 5G, the first magnetic body 170a thicker than a depth of the depression 182 can be disposed in the depression 182. In addition, the hook 184 can prevent peeling of the first magnetic body 170a from the depression 182.

In FIGS. 5D to 5G, the two hooks 184 are arranged side by side in the Y-direction, but the present disclosure is not limited thereto. The two hooks 184 may be arranged side by side in the Z-direction. One hook 184 may be disposed in each of the Z-direction and the Y-direction. The number of hooks 184 may be one or at least three.

The optical assembly 100 may further include an adhesive portion 183 that adheres to at least one of the reinforcing plate 181 and the FPC 180 to the first magnetic body 170a.

With the above configuration, the first magnetic body 170a can be more easily fixed to the fixed body 110. Thus, a yield of the optical assembly 100 can be improved.

Typically, the adhesive portion 183 is an ultraviolet-curable adhesive or a thermosetting adhesive. The adhesive portion 183 is not limited to the ultraviolet-curable adhesive or the thermosetting adhesive as long as it can adhere at least one of the reinforcing plate 181 and the FPC 180 to the first magnetic body 170a. For example, the adhesive portion 183 may be solder or an adhesive sheet.

At least a part of the adhesive portion 183 may be located on the +X-side with respect to the first magnetic body 170a.

With the above configuration, the first magnetic body 170a is in contact with the adhesive portion 183 on the +X-direction side, and is supported by the FPC 180 or the reinforcing plate 181 on the −X-direction side. As a result, the first magnetic body 170a is fixed from both sides in the X-direction. Consequently, the possibility that the first magnetic body 170a is peeled off from the fixed body 110 can be reduced.

As illustrated in FIG. 5B, when viewed from the X direction, a gap 182b separating the reinforcing plate 181 and the first magnetic body 170a exists, and at least a part of the adhesive portions 183 may be located in the gap 182b and in contact with each of the reinforcing plate 181 and the first magnetic body 170a.

With the above configuration, the adhesive portion 183 is easily held in the depression 182. Accordingly, with the above configuration, the first magnetic body 170a can be more easily fixed on the fixed body 110. Thus, a yield of the optical assembly 100 can be improved. Furthermore, the rigidity of the reinforcing plate 181 can be reinforced by the adhesive portion 183.

Typically, as illustrated in FIGS. 6A and 6B, the adhesive portion 183 is located on the +X-side with respect to the first magnetic body 170a along the entire outer periphery of the edge of the first magnetic body 170a. That is, the first magnetic body 170a is located on the +X-side in a substantially annular shape. The adhesive portion 183 may be located on the +X-side with respect to the first magnetic body 170a along a part of the outer periphery of the first magnetic body 170a. As illustrated in FIGS. 7A and 7B, the adhesive portion 183 may cover the entire surface of the first magnetic body 170a. As the amount of the adhesive portion 183 increases, the effect of reinforcing the rigidity of the reinforcing plate 181 by the adhesive portion 183 is easily obtained. In particular, in the configuration in which the adhesive portion 183 covers the entire surface of the first magnetic body 170a, because the adhesive portion 183 is introduced so as to fill the depression 182 of the reinforcing plate 181, the effect of reinforcing the rigidity of the reinforcing plate 181 can be strongly obtained.

The length in the X-direction of the depression 182 may be longer than the length in the X-direction of the first magnetic body 170a. In other words, the depression 182 is depressed deeper than the thickness of the first magnetic body 170a.

With the above configuration, in the X-direction, the first magnetic body 170a is completely accommodated in the depression 182. That is, in the X-direction, the first magnetic body 170a does not protrude from the depression 182. In other words, after the first magnetic body 170a is disposed in the depression 182, the end surface in the +X-direction of the first magnetic body 170a is located in the −X-direction with respect to the end surface in the +X-direction of the reinforcing plate 181. Thus, the first magnetic body 170a is easily disposed in the depression 182. Furthermore, the peeling of the first magnetic body 170a from the fixed body 110 can be prevented.

In addition, after the first magnetic body 170a is disposed in the depression 182, the depression having the end surface in the +X-direction of the first magnetic body 170a as a bottom surface is generated. In this case, the adhesive flows from the +X-direction after the first magnetic body 170a is accommodated in the depression 182, so that the configuration in which the adhesive portion 183 covers the entire surface of the first magnetic body 170a can be easily implemented.

The first magnetic body 170a may be in contact with the reinforcing plate 181 on one side and the other side in an arbitrary direction perpendicular to the X-direction. In other words, the first magnetic body 170a is in contact with the reinforcing plate 181 on one side and the other side in at least one arbitrary direction extending in parallel to the YZ-plane.

With the above configuration, the first magnetic body 170a can be positioned from both sides in an arbitrary direction perpendicular to the X-direction. Accordingly, the first magnetic body 170a can be installed on the fixed body 110 with higher accuracy. Thus, a yield of the optical assembly 100 can be improved.

In particular, the first magnetic body 170a may be in contact with the reinforcing plate 181 on one side and the other side in any at least two directions perpendicular to the X-direction. In other words, the first magnetic body 170a is in contact with the reinforcing plate 181 in any at least two directions extending in parallel to the YZ-plane.

With the above configuration, the first magnetic body 170a can be positioned from both sides in any at least two directions perpendicular to the X-direction. In this case, as compared with the configuration in which the first magnetic body 170a is positioned from both sides in one arbitrary direction perpendicular to the X-direction, one point on the YZ-plane can be determined, so that the positioning is easier. Accordingly, the first magnetic body 170a can be installed on the fixed body 110 with higher accuracy. Thus, the yield of the optical assembly 100 can be further improved.

The fixed body 110 may have a step 113 protruding in the X-direction, and the FPC 180 may be disposed along the step 113 in an arbitrary direction perpendicular to the X-direction.

With the above configuration, the FPC 180 can be positioned on the fixed body in an arbitrary direction perpendicular to the X-direction. Thus, a yield of the optical assembly 100 can be improved. In the example embodiment, the FPC 180 is disposed along the step 113 in the Y-direction.

The fixed body 110 may include the step 113 protruding in the X-direction, and the FPC 180 may be disposed along the step 113 on one side and the other side in an arbitrary direction perpendicular to the X-direction.

With the above configuration, the FPC 180 can be positioned on the fixed body from both sides in an arbitrary direction perpendicular to the X-direction. Thus, a yield of the optical assembly 100 can be improved. In the example embodiment, the FPC 180 is disposed along the step 113 on one side and the other side in the Y-direction.

As illustrated in FIGS. 8A and 8B, the fixed body 110 may include the step 113 protruding in the X-direction, and the FPC 180 may be disposed along the step 113 in any two directions perpendicular to the X-direction.

With the above configuration, the FPC 180 can be positioned on the fixed body in any at least two directions perpendicular to the X-direction. In this case, as compared with the configuration in which the FPC 180 is positioned on the fixed body only in one arbitrary direction perpendicular to the X-direction, one point on the YZ-plane can be determined, so that the positioning is more stable. Accordingly, the FPC 180 can be installed on the fixed body 110 with higher accuracy. Thus, the yield of the optical assembly 100 can be further improved. In the example embodiment, the FPC 180 is disposed along the step 113 in the Y-direction and the Z-direction.

The first swing mechanism 152 swings the movable body 120 with respect to the fixed body 110 about the first swing axis Sa1. The first swing mechanism 152 swings the movable body 120 with respect to the fixed body 110.

Typically, the first swing mechanism 152 is disposed in both the fixed body 110 and the movable body 120. The first swing mechanism 152 may include a magnet and a coil.

At this point, the coil is disposed on the fixed body 110, the first magnet 162 is disposed on the movable body 120, and the first magnetic body 170a is disposed on the fixed body 110. The coil is electrically connected to the FPC 180, and can supply driving power through the FPC 180.

The optical assembly 100 is preferably manufactured in a small size. For example, when the optical assembly 100 is incorporated in the smartphone of FIG. 1, the size (for example, the length of the fixed body 110 along the X-axis direction or the Y-axis direction) of the optical assembly 100 is greater than or equal to 10 mm and less than or equal to 50 mm.

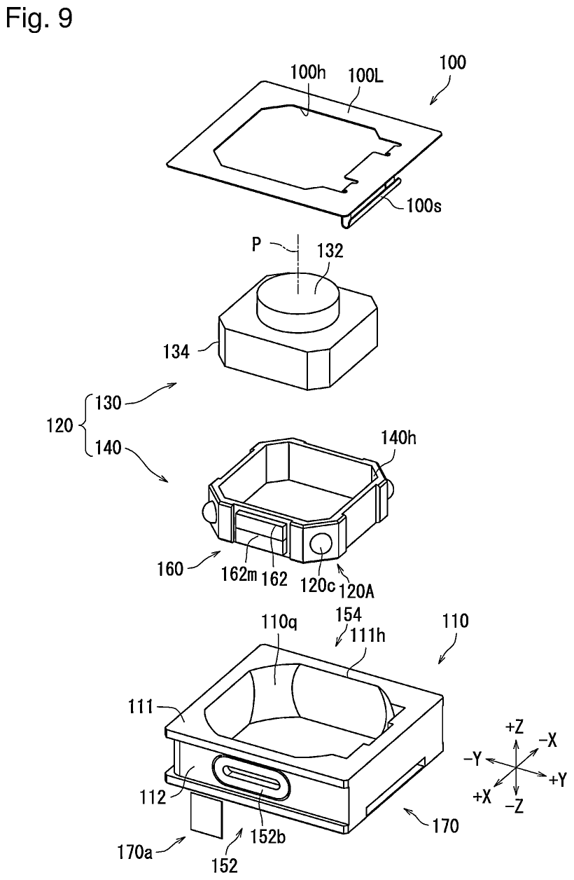

With reference to FIGS. 1 to 9, a configuration of the optical assembly 100 in the example embodiment of the present disclosure will be described below. FIG. 9 is a schematic exploded perspective view illustrating the optical assembly 100 of the example embodiment of the present disclosure. In FIG. 9, the FPC 180 is omitted.

The fixed body 110 has a substantially tubular shape. The outer shape of the fixed body 110 is a rectangular parallelepiped shape with a through-hole having a substantially rectangular section. For example, the fixed body 110 is made of resin. The fixed body 110 includes a frame portion 111 and a side portion 112. The side portion 112 is supported by the frame portion 111. An opening 111h is formed in the frame portion 111.

As illustrated in FIG. 9, the fixed body 110 includes a plurality of recesses 110q. The recess 110q is located on an inner peripheral surface of the side portion 112. When the movable body 120 is inserted into the fixed body 110, the recess 110q comes into contact with the movable body 120. Typically, when the movable body 120 swings with respect to the fixed body 110, the movable body 120 slides on the recess 110q while being in contact with the recess 110q. Each of the plurality of recesses 110q preferably includes a part of a concave spherical surface.

The recesses 110q are disposed at four corners of the fixed body 110. Curvature radii of the four recesses 110q may be the same. In this case, the four recesses 110q may form parts of one large concave spherical surface. Alternatively, the curvature radii of the four recesses 110q may be different.

The movable body 120 further includes a contact member 120A. The contact member 120A is disposed on an outer surface of the movable body 120. The contact member 120A is in contact with the fixed body 110. The movable body 120 is in contact with the fixed body 110 with the contact member 120A interposed therebetween, so that the movable body 120 can be stably supported with respect to the fixed body 110. In this case, when being inserted into the fixed body 110, the movable body 120 comes into contact with the fixed body 110. However, even when being inserted into the fixed body 110, the movable body 120 may not come into contact with the fixed body 110.

The movable body 120 includes the optical element 130 and a holder 140. The optical element 130 is inserted into the frame of the holder 140.

The optical element 130 includes the lens 132 and the housing 134. The housing 134 has a thin rectangular parallelepiped shape. The lens 132 is disposed in the housing 134. For example, the lens 132 is disposed on the optical axis P at the center of one surface of the housing 134. The optical axis P and the lens 132 face the subject, and the light from the direction along the optical axis P is incident on the optical element 130.

An image sensor or the like may be built in the housing 134. In this case, a flexible printed circuit (FPC) is preferably connected to the image sensor. A signal captured by the optical element 130 is extracted to the outside through the FPC.

The holder 140 has a frame shape. The holder 140 surrounds the optical element 130 from the outside and holds the optical element 130. For example, the holder 140 is made of resin. The holder 140 has a tubular shape and includes a through-hole 140h. The optical element 130 is inserted into the through-hole 140h of the holder 140.

The contact member 120A is disposed on an outer peripheral surface of the holder 140. The contact member 120A is in contact with the fixed body 110.

The movable body 120 includes a plurality of protrusions 120c protruding toward the fixed body 110. Specifically, the movable body 120 includes the contact member 120A, and the contact member 120A includes the plurality of protrusions 120c protruding toward the fixed body 110. The protrusion 120c is located on the radially outer side of the holder 140. The protrusion 120c protrudes radially outward from the holder 140 and comes into contact with the fixed body 110. Thus, the movable body 120 can be smoothly moved with respect to the fixed body 110.

The protrusion 120c may have a curved shape protruding in a curved manner. For example, the protrusion 120c is curved in a spherical shape. Each of the plurality of protrusions 120c preferably has a part of a spherical surface. Thus, the movable body 120 can be smoothly moved with respect to the fixed body 110.

The first swing mechanism 152 swings the movable body 120 with respect to the fixed body 110 about the first swing axis Sa1. The first swing axis Sa1 extends in parallel to the Y-axis direction.

The first swing mechanism 152 includes the first magnet 162 and a coil 152b. Typically, the first magnet 162 is a permanent magnet. The coil 152b is opposite to the first magnet 162. The first magnet 162 is included in the movable body 120, and the coil 152b is included in the fixed body 110. The movable body 120 can be swung with respect to the fixed body 110 by the first magnet 162 and the coil 152b.

The first magnet 162 is located on the +X-direction side of the movable body 120, and the coil 152b is located on a side portion on the +X-direction side of the fixed body 110.

The first magnet 162 is magnetized such that the magnetic pole of the surface facing a radial outside (+X-direction side) is different on either side of a first magnetization polarization line 162m extending along the Y-axis direction. One end along the Z-axis direction of the first magnet 162 has one polarity, and the other end has the other polarity.

For example, the yawing of the movable body 120 is corrected as follows. When shake in the yawing direction is generated in the optical assembly 100, the shake is detected by a magnetic sensor (Hall element) (not illustrated), and the first swing mechanism 152 is driven based on the result. The shake of the optical assembly 100 may be detected using a shake detection sensor (gyroscope) or the like. The first swing mechanism 152 corrects the shake based on the detection result of the shake.

The magnet 160 generates a magnetic field. Typically, the magnet 160 is a permanent magnet. In this case, the magnet 160 includes the first magnet 162. The first magnet 162 is attached to a side surface of the holder 140 and located on an outer surface of the movable body 120.

The first magnet 162 is located on the +X-direction side with respect to the movable body 120 and extends in the Y-axis direction.

The first magnetic body 170a is disposed to be opposite to the first magnet 162. The first magnetic body 170a is located on the +X-direction of the movable body 120 and is opposite to the first magnet 162.

The first magnetic body 170a is preferably a soft magnetic material. The first magnetic body 170a is a soft magnetic material, so that the first magnet 162 can be attracted to a predetermined position by relatively weak magnetic action as compared with the case where the first magnetic body 170a is a permanent magnet. For this reason, even when the driving force from the first swing mechanism 152 is relatively weak, the movable body 120 can be appropriately moved.

As understood from FIG. 9, the movable body 120 is produced by inserting the optical element 130 into the holder 140. The first magnet 162 is disposed along the Y-axis direction on the outer surface of the movable body 120.

The first magnetic body 170a is disposed in the fixed body 110. When the movable body 120 is inserted into the fixed body 110, the first magnet 162 is opposite to the first magnetic body 170a.

The reinforcing plate 181 is a plate-like member. Typically, the rigidity of the reinforcing plate 181 is higher than that of the FPC 180. The rigidity of the reinforcing plate 181 may be lower than that of the FPC 180.

As a typical example, the material of the reinforcing plate 181 is resin or metal. The reinforcing plate 181 is disposed on the FPC 180. That is, the reinforcing plate 181 is disposed so as to overlap in the thickness direction of the FPC 180.

The rigidity of a place of the FPC 180 to which the reinforcing plate 181 is attached increases by attaching the reinforcing plate 181 to the FPC 180. Consequently, this contributes to the improvement of workability such as the attachment of the FPC 180 to the fixed body.

Preferably, the length in the width direction of the reinforcing plate 181 is substantially matched with the length in the width direction of the FPC 180. In this case, it is easier to accurately attach the reinforcing plate 181 to the FPC 180 using a jig or the like.

Typically, the reinforcing plate 181 adheres to the FPC 180 by the adhesive. At this point, one surface of the reinforcing plate 181 may be an adhesive sheet, or an adhesive of a solvent may be separately applied.

Adhesive means of the reinforcing plate 181 to the FPC 180 is not limited thereto. Other means may be used as long as the reinforcing plate 181 can be fixed to the FPC 180.

Typically, the FPC 180 is disposed on the fixed body 110 after the reinforcing plate 181 and the first magnetic body 170a adhere to the FPC 180. After the FPC 180 is disposed on the fixed body 110, the reinforcing plate 181 and the first magnetic body 170a may be disposed on the FPC 180.

The lid 100L covers the fixed body 110 and the movable body 120. For example, the lid 100L is formed of metal. The lid 100L may be formed of resin. The lid 100L is a plate-like member having the thickness in the Z-axis direction. The lid 100L is fixed to the +Z-direction side (one side in the optical axis direction) of the fixed body 110. In the example embodiment, the lid 100L is fixed to the frame portion 111 of the fixed body 110. The configuration is which the lid 100L is fixed to the fixed body 110 is not particularly limited. For example, the lid 100L may be fixed to the fixed body 110 using a fastening member such as a screw, or fixed to the fixed body 110 using an adhesive.

The lid 100L has a hole 100h and a rotation stopper 100s. The rotation stopper 100s comes into contact with the movable body 120 to restrict excessive rotation in the rolling direction of the movable body 120. The hole 100h penetrates the lid 100L in the Z-axis direction. The hole 100h of the lid 100L is opposite to the opening 111h of the fixed body 110. The lens 132 of the movable body 120 is exposed to the outside of the fixed body 110 through the opening 111h of the fixed body 110 and the hole 100h of the lid 100L.

As described above, one of the movable body 120 and the fixed body 110 includes the plurality of protrusions 120c. The other of the movable body 120 and the fixed body 110 includes the plurality of recesses 110q. For this reason, slidability of the movable body 120 with respect to the fixed body 110 can be improved. At this point, the movable body 120 includes the plurality of protrusions 120c, and the fixed body 110 includes the plurality of recesses 110q.

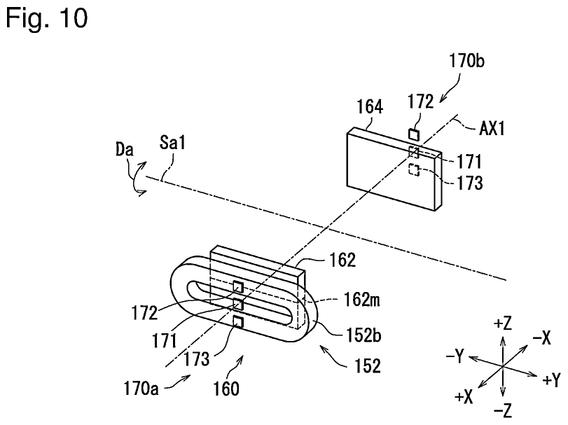

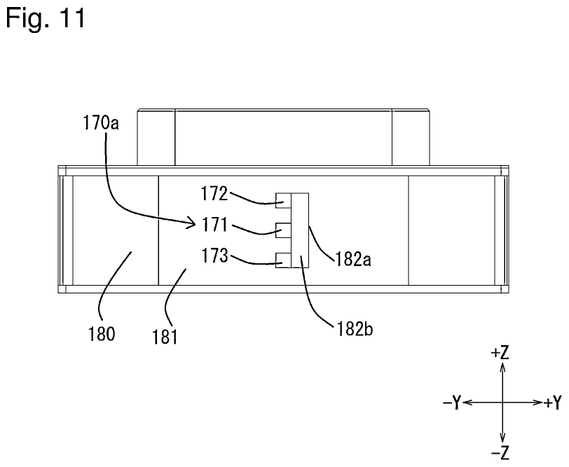

With reference to FIGS. 10 and 11, an optical assembly 100 according to a modification of the example embodiment of the present disclosure will be described below. FIG. 10 is a schematic perspective view illustrating the first swing mechanism 152, the magnet 160, and the first magnetic body 170a. The first magnetic body 170a has the same configuration as the optical assembly 100 described above with reference to FIG. 6 except that the first magnetic body 170a further includes a first magnetic body portion 171, a second magnetic body portion 172, and the third magnetic body portion 173, and redundant description is omitted for the purpose of avoiding redundancy.

As illustrated in FIG. 10, the first swing mechanism 152 includes the first magnet 162 and the coil 152b. The first magnet 162 is magnetized such that the magnetic pole of a surface facing the radial outside is different on either side of the first magnetization polarization line 162m extending along the Y-axis direction. One end along the Z-axis direction of the first magnet 162 has one polarity, and the other end has the other polarity.

By controlling the direction and the magnitude of the current flowing through the coil 152b, the direction and the magnitude of the magnetic field generated from the coil 152b can be changed. For this reason, the first swing mechanism 152 can swing the movable body 120 about the first swing axis Sa1 by the interaction between the magnetic field generated from the coil 152b and the first magnet 162.

The first magnetic body portion 171, the second magnetic body portion 172, and the third magnetic body portion 173 are disposed perpendicular to the first magnetization polarization line 162m of the first magnet 162. Accordingly, the magnetic force can be effectively used.

At this time, for example, the reinforcing plate 181 preferably has a shape in FIG. 11.

In FIG. 11, the depression 182 of the reinforcing plate 181 includes a rectangular through-hole linearly disposed and penetrating in the X-direction, and a through-hole extending from a total of 3 places of an upper end, a lower end, and an intermediate portion in the Z-direction of the rectangular through-hole to the +Y-side and penetrating in the X-direction. The first magnetic body portion 171, the second magnetic body portion 172, and the third magnetic body portion 173 are in contact with the peripheral surface 182a of the depression 182 with three sides interposed therebetween. At this time, the gap 182b is generated on the +Y-side between the first magnetic body portion 171, the second magnetic body portion 172, and the third magnetic body portion 173 and the peripheral surface 182a. The adhesive portion 183 can be inserted into the gap 182b.

The magnet 160 preferably further includes a second magnet 164 in addition to the first magnet 162. The second magnet 164 is attached to the side surface of the holder 140 (see FIG. 9) and is located on the outer surface of the movable body 120. The second magnet 164 is disposed on the −X-direction side.

Preferably the optical assembly 100 further includes a second magnetic body 170b. The second magnetic body 170b is located on the −X-direction side of the second magnet 164. Similarly to the first magnetic body 170a, the second magnetic body 170b includes the first magnetic body portion 171, the second magnetic body portion 172, and the third magnetic body portion 173. In the second magnetic body 170b, similarly to the first magnetic body 170a, the magnetic body is disposed along the first swing direction Da. Accordingly, in addition to the first magnetic body 170a, the second magnetic body 170b can also reduce the driving resistance when the movable body 120 is swung in the first swing direction Da. Accordingly, the driving resistance can be reduced even more than the case where only one magnetic body exists on one side.

In the optical assembly 100 described above with reference to FIGS. 10 and 11, the first swing mechanism 152 swings around the first swing axis Sa1 with respect to the fixed body 110. However, the example embodiment is not limited thereto. The movable body 120 may swing about an axis different from the first swing axis Sa1 with respect to the fixed body 110.

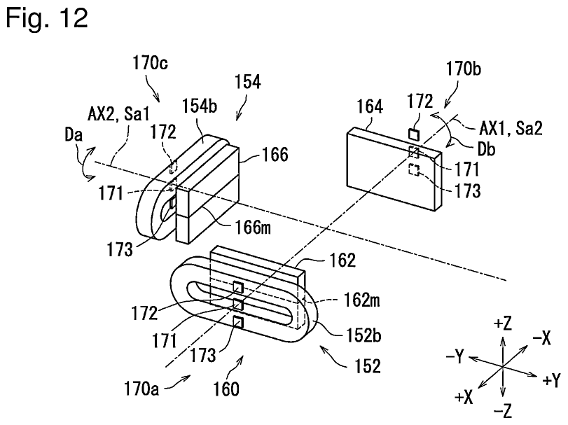

With reference to FIG. 12, an optical assembly 100 according to a modification of the example embodiment of the present disclosure will be described below. FIG. 12 is a schematic perspective view illustrating the first swing mechanism 152, a second swing mechanism 154, the magnet 160, the first magnetic body 170a, the second magnetic body 170b, and a third magnetic body 170c in the optical assembly 100 of the example embodiment of the present disclosure. The optical assembly 100 in FIG. 12 has a configuration similar to the optical assembly 100 described above with reference to FIG. 11 except that the optical assembly 100 in FIG. 12 further includes the second swing mechanism 154, a third magnet 166, and the third magnetic body 170c, and redundant description will be omitted for the purpose of avoiding redundancy.

As illustrated in FIG. 12, the magnet 160 includes the third magnet 166 in addition to the first magnet 162 and the second magnet 164. Additionally, the optical assembly 100 further includes the third magnetic body 170c in addition to the first magnetic body 170a and the second magnetic body 170b. The first magnetic body 170a, the second magnetic body 170b, and the third magnetic body 170c are opposite to the first magnet 162, the second magnet 164, and the third magnet 166, respectively. As described above, one of the fixed body 110 and the movable body 120 further includes the third magnet 166, and the other of the fixed body 110 and the movable body 120 further includes the third magnetic body 170c opposite to the third magnet 166. In this case, the movable body 120 further includes the third magnet 166, and the fixed body 110 further includes the third magnetic body 170c.

The first magnet 162 is located on the +X-direction side of the movable body 120. The second magnet 164 is located on the −X-direction side of the movable body 120. The third magnet 166 is located on the −Y-direction side of the movable body 120.

The first magnetic body 170a is located on the +X-direction side of the movable body 120. The second magnetic body 170b is located on the −X-direction side of the movable body 120. The third magnetic body 170c is located on the −Y-direction side of the movable body 120.

The first swing mechanism 152 swings the movable body 120 with respect to the fixed body 110. Specifically, the first swing mechanism 152 swings the movable body 120 about the first swing axis Sa1 with respect to the fixed body 110. For example, the first swing axis Sa1 extends parallel to the Y-axis direction. The Y-axis direction is a direction intersecting with the optical axis P, and is an axis of rotation in a yawing direction.

The first swing mechanism 152 uses the magnet 160. In this case, the first swing mechanism 152 includes the first magnet 162 and the coil 152b. The first magnet 162 is magnetized such that the magnetic pole of a surface facing the radial outside is different on either side of the first magnetization polarization line 162m extending along the Y-axis direction. One end along the Z-axis direction of the first magnet 162 has one polarity, and the other end has the other polarity.

By controlling the direction and the magnitude of the current flowing through the coil 152b, the direction and the magnitude of the magnetic field generated from the coil 152b can be changed. For this reason, the first swing mechanism 152 can swing the movable body 120 about the first swing axis Sa1 by the interaction between the magnetic field generated from the coil 152b and the first magnet 162.

The optical assembly 100 further includes the second swing mechanism 154 in addition to the first swing mechanism 152. The second swing mechanism 154 swings the movable body 120 about a second swing axis Sa2 with respect to the fixed body 110. The second swing axis Sa2 is orthogonal to the first swing axis Sa1. For example, the second swing axis Sa2 extends in parallel to the X-axis direction. The X-axis direction is a direction intersecting with the optical axis P, and is the axis of rotation in the pitching direction. The second swing axis Sa2 is a virtual axis.

In FIG. 12, the second swing mechanism 154 uses the magnet 160. In this case, the second swing mechanism 154 includes the third magnet 166 and a coil 154b. The third magnet 166 is magnetized such that the magnetic pole of the surface facing the radial outside is different on either side of a third magnetization polarization line 166m extending along the X-axis direction. One end along the Z-axis direction of the third magnet 166 has one polarity, and the other end has the other polarity.

By controlling the direction and the magnitude of the current flowing through the coil 154b, the direction and the magnitude of the magnetic field generated from the coil 154b can be changed. For this reason, the second swing mechanism 154 can swing the movable body 120 about the second swing axis Sa2 by the interaction between the magnetic field generated from the coil 154b and the first magnet 162.

As described above, the first swing mechanism 152 includes the first magnet 162 and the coil 152b opposite to the first magnet 162. Additionally, the second swing mechanism 154 includes the third magnet 166 and the coil 154b opposite to the third magnet 166. For this reason, the first magnet 162 and the third magnet 166, which stably swing the movable body 120, can be used for the first swing mechanism 152 and the second swing mechanism 154.

The second magnetic body 170b is located on the −X-direction side of the second magnet 164. The third magnetic body 170c is located on the −Y-direction side of the third magnet 166. Similarly to the first magnetic body 170a and the second magnetic body 170b, the third magnetic body 170c includes the first magnetic body portion 171, the second magnetic body portion 172, and the third magnetic body portion 173.

The first magnetic body portion 171 of the third magnetic body 170c passes through an axis AX2 perpendicular to each of the first swing axis Sa1 and the optical axis P of the optical element 130. The first magnetic body portion 171 of the third magnetic body 170c is opposite to the third magnet 166. Accordingly, the movable body 120 can be held at an initial position. The initial position indicates a position where the movable body 120 is not swung with respect to the fixed body 110 and the state in which the optical axis P is parallel to the Z-axis direction is maintained.

The second magnetic body portion 172 of the third magnetic body 170c is disposed on one side in a second swing direction Db of the first magnetic body portion 171 of the third magnetic body 170c. In this case, the second magnetic body portion 172 of the third magnetic body 170c is disposed on the +Z-direction side with respect to the first magnetic body portion 171 of the third magnetic body 170c. Accordingly, when the movable body 120 is swung to one side in the second swing direction Db, the second magnetic body portion 172 of the third magnetic body 170c can generate the adsorption force as an aid. As a result, the driving resistance can be reduced when the movable body 120 is swung to one side in the second swing direction Db. The second swing direction Db is a direction in which the movable body 120 swings with respect to the fixed body 110 about the second swing axis Sa2.

The third magnetic body portion 173 of the third magnetic body 170c is disposed on the other side in the second swing direction Db with respect to the first magnetic body portion 171 of the third magnetic body 170c. In this case, the third magnetic body portion 173 of the third magnetic body 170c is disposed on the −Z-direction side with respect to the first magnetic body portion 171 of the third magnetic body 170c. Accordingly, when the movable body 120 is swung to the other side in the second swing direction Db, the third magnetic body portion 173 can generate the adsorption force as an aid. As a result, the driving resistance can be reduced when the movable body 120 is swung to the other side in the second swing direction Db.

In this manner, the magnetic body is disposed along the second swing direction Db. Accordingly, the driving resistance can be reduced when the movable body 120 is swung in the second swing direction Db as well.

The optical assembly 100 described above with reference to FIG. 12 includes the first magnetic body 170a, the second magnetic body 170b, and the third magnetic body 170c, but the present example embodiment is not limited thereto. The optical assembly 100 may further include a fourth magnetic body 170d.

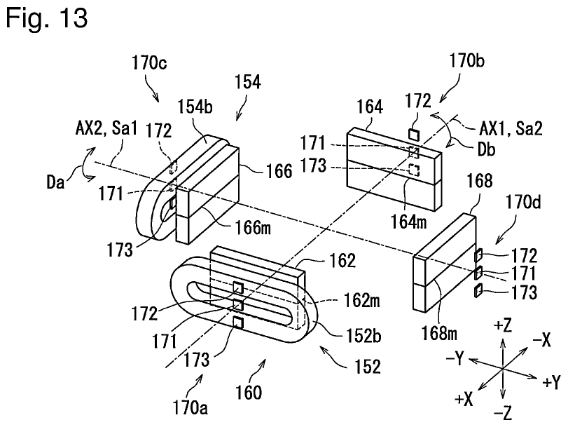

With reference to FIG. 13, an optical assembly 100 in the example embodiment of the present disclosure will be described below. FIG. 13 is a schematic perspective view illustrating the first swing mechanism 152, the second swing mechanism 154, the magnet 160, and the first magnetic body 170a, the second magnetic body 170b, the third magnetic body 170c, and the fourth magnetic body 170d in the optical assembly 100 of the example embodiment of the present disclosure. The optical assembly 100 in FIG. 13 has a configuration similar to the optical assembly 100 described above with reference to FIG. 12 except that the magnet 160 further includes a fourth magnet 168 and that the optical assembly 100 in FIG. 13 further includes the fourth magnetic body 170d, and redundant description will be omitted for the purpose of avoiding redundancy.

The magnet 160 includes the fourth magnet 168 in addition to the first magnet 162, the second magnet 164, and the third magnet 166. The first magnet 162 is located on the +X-direction side of the movable body 120, and the second magnet 164 is located on the −X-direction side of the movable body 120. The third magnet 166 is located on the −Y-direction side of the movable body 120, and the fourth magnet 168 is located on the +Y-direction side of the movable body 120.

Additionally, the optical assembly 100 includes the fourth magnetic body 170d in addition to the first magnetic body 170a, the second magnetic body 170b, and the third magnetic body 170c. The first magnetic body 170a, the second magnetic body 170b, the third magnetic body 170c, and the fourth magnetic body 170d are opposite to the first magnet 162, the second magnet 164, the third magnet 166, and the fourth magnet 168, respectively. The first magnetic body 170a is located on the +X-direction side of the movable body 120, and the second magnetic body 170b is located on the −X-direction side of the movable body 120. The third magnetic body 170c is located on the −Y-direction side of the movable body 120, and the fourth magnetic body 170d is located on the +Y-direction side of the movable body 120.

Similarly to the third magnetic body 170c, the fourth magnetic body 170d includes the first magnetic body portion 171, the second magnetic body portion 172, and the third magnetic body portion 173. In the fourth magnetic body 170d, similarly to the third magnetic body 170c, the magnetic body is disposed along the second swing direction Db. Accordingly, in addition to the third magnetic body 170c, the fourth magnetic body 170d can also reduce the driving resistance when swinging the movable body 120 in the second swing direction Db. Accordingly, the driving resistance can be reduced even more than the case where only one magnetic body exists on one side.

In this case, the first magnetization polarization line 162m of the first magnet 162 extends in parallel with a second magnetization polarization line 164m of the second magnet 164. Specifically, the first magnet 162 is magnetized such that the magnetic pole of the surface facing the radial outside is different on either side of the first magnetization polarization line 162m extending along the Y-axis direction. One end along the Z-axis direction of the first magnet 162 has one polarity, and the other end has the other polarity. Similarly, the second magnet 164 is magnetized such that the magnetic pole of the surface facing the radial outside is different on either side of the second magnetization polarization line 164m extending along the Y-axis direction. One end of the second magnet 164 along the Z-axis direction has one polarity, and the other end has the other polarity.

Additionally, the third magnetization polarization line 166m of the third magnet 166 extends in parallel with a fourth magnetization polarization line 168m of the fourth magnet 168. Specifically, the third magnet 166 is magnetized such that the magnetic pole of the surface facing the radial outside is different on either side of the third magnetization polarization line 166m extending along the X-axis direction. One end along the Z-axis direction of the third magnet 166 has one polarity, and the other end has the other polarity. Similarly, the fourth magnet 168 is magnetized such that the magnetic pole of the surface facing the radial outside is different on either side of the fourth magnetization polarization line 168m extending along the X-axis direction. One end of the fourth magnet 168 along the Z-axis direction has one polarity, and the other end has the other polarity.

However, the first magnetization polarization line 162m of the first magnet 162 may not have to be parallel to the second magnetization polarization line 164m of the second magnet 164, and the extending direction of the first magnetization polarization line 162m of the first magnet 162 may be shifted from the extending direction of the second magnetization polarization line 164m of the second magnet 164. In this case, the extending direction of the first magnetization polarization line 162m of the first magnet 162 is preferably shifted by 90° with respect to the extending direction of the second magnetization polarization line 164m of the second magnet 164. Thus, the frictional resistance when the movable body 120 swings about the second swing axis Sa2 can be further reduced.

Additionally, in the above description with reference to FIG. 13, the movable body 120 swings about one swing axis (first swing axis Sa1) with respect to the fixed body 110 or two orthogonal swing axes (first swing axis Sa1 and second swing axis Sa2). However, the example embodiment is not limited thereto. The movable body 120 may swing about three swing axes with respect to the fixed body 110.

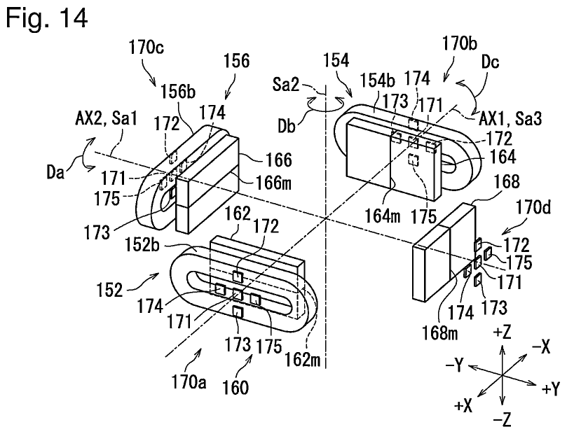

With reference to FIG. 14, a configuration of the optical assembly 100 in the modification of the example embodiment of the present disclosure will be described below. FIG. 14 is a schematic perspective view illustrating the first swing mechanism 152, the second swing mechanism 154, the third swing mechanism 156, the magnet 160, the first magnetic body 170a, the second magnetic body 170b, the third magnetic body 170c, and the fourth magnetic body 170d in the optical assembly 100 in the modification of the example embodiment of the present disclosure. The optical assembly 100 in FIG. 14 is mainly different from the optical assembly 100 described above with reference to FIG. 8 in that the optical assembly 100 in FIG. 14 includes the third swing mechanism 156 in addition to the first swing mechanism 152 and the second swing mechanism 154 and that the second swing axis Sa2 is parallel to the optical axis P. The description of the configuration similar to that of the optical assembly 100 described above with reference to FIG. 13 will be omitted to avoid redundancy.

As illustrated in FIG. 14, the optical assembly 100 includes the third swing mechanism 156 in addition to the first swing mechanism 152 and the second swing mechanism 154.

The first swing mechanism 152 swings the movable body 120 with respect to the fixed body 110. Specifically, the first swing mechanism 152 swings the movable body 120 about the first swing axis Sa1 with respect to the fixed body 110. In this case, the first swing axis Sa1 extends in parallel to the Y-axis direction. The Y-axis direction is a direction intersecting with the optical axis P, and is an axis of rotation in a yawing direction. Typically, the first swing axis Sa1 is orthogonal to the optical axis P.

The second swing mechanism 154 swings the movable body 120 with respect to the fixed body 110. Specifically, the second swing mechanism 154 swings the movable body 120 about the second swing axis Sa2 with respect to the fixed body 110. In this case, the second swing axis Sa2 extends in parallel to the Z-axis direction. The Z-axis direction is parallel to the optical axis P and is the axis of rotation in the rolling direction.

The third swing mechanism 156 swings the movable body 120 with respect to the fixed body 110. Specifically, the third swing mechanism 156 swings the movable body 120 about a third swing axis Sa3 with respect to the fixed body 110. In this case, the third swing axis Sa3 extends in parallel to the X-axis direction. The X-axis direction is a direction intersecting with the optical axis P, and is the axis of rotation in the pitching direction. Typically, the third swing axis Sa3 is orthogonal to the optical axis P. The third swing axis Sa3 is a virtual axis.

The fixed body 110 supports the movable body 120 so as to be swingable in the second swing direction Db about the second swing axis Sa2. The fixed body 110 supports the movable body 120 so as to be swingable in a third swing direction Dc about the third swing axis Sa3. The third swing direction Dc is a direction in which the movable body 120 swings with respect to the fixed body 110 about the third swing axis Sa3.

The first swing axis Sa1, the second swing axis Sa2, and the third swing axis Sa3 are orthogonal to one another. One of the first swing axis Sa1 and the second swing axis Sa2 is perpendicular to the optical axis P. In this case, the first swing axis Sa1 is perpendicular to the optical axis P. One of the first swing axis Sa1, the second swing axis Sa2, and the third swing axis Sa3 is parallel to the optical axis P. The other of the first swing axis Sa1 and the second swing axis Sa2 is parallel to the optical axis P. In this case, the second swing axis Sa2 is parallel to the optical axis P.

One of the movable body 120 and the fixed body 110 includes the first magnet 162, the second magnet 164, the third magnet 166, and the fourth magnet 168. In this case, the movable body 120 includes the first magnet 162, the second magnet 164, the third magnet 166, and the fourth magnet 168. The other of the movable body 120 and the fixed body 110 includes the first magnetic body 170a, the second magnetic body 170b, the third magnetic body 170c, and the fourth magnetic body 170d. In this case, the fixed body 110 includes the first magnetic body 170a, the second magnetic body 170b, the third magnetic body 170c, and the fourth magnetic body 170d.

The first swing mechanism 152 includes the first magnet 162 and the coil 152b. The first magnet 162 is magnetized such that the magnetic pole of a surface facing the radial outside is different on either side of the first magnetization polarization line 162m extending along the Y-axis direction. One end along the Z-axis direction of the first magnet 162 has one polarity, and the other end has the other polarity.

In this case, the second swing mechanism 154 includes the second magnet 164 and the coil 154b. The second magnet 164 is magnetized such that the magnetic pole of the surface facing the radial outside is different on either side of the second magnetization polarization line 164m extending along the Z-axis direction. One end of the second magnet 164 along the Y-axis direction has one polarity, and the other end has the other polarity.

In this case, the third swing mechanism 156 includes the third magnet 166 and a coil 156b. The third magnet 166 is magnetized such that the magnetic pole of the surface facing the radial outside is different on either side of a third magnetization polarization line 166m extending along the X-axis direction. One end along the Z-axis direction of the third magnet 166 has one polarity, and the other end has the other polarity.

The fourth magnet 168 is magnetized such that the magnetic pole of the surface facing the radial outside is different on either side of the fourth magnetization polarization line 168m extending along the Z-axis direction. One end of the fourth magnet 168 along the X-axis direction has one polarity, and the other end has the other polarity.

In the optical assembly 100 of FIG. 14, the first swing mechanism 152 can swing the movable body 120 in the yawing direction, the second swing mechanism 154 can swing the movable body 120 in the rolling direction, and the third swing mechanism 156 can swing the movable body 120 in the pitching direction. For this reason, in the optical assembly 100, the movable body 120 can be corrected in an arbitrary direction.

In the optical assembly 100 of FIG. 14, the extending direction of the first magnetization polarization line 162m is shifted from the extending direction of the second magnetization polarization line 164m, and the extending direction of the third magnetization polarization line 166m is shifted from the extending direction of the fourth magnetization polarization line 168m of the fourth magnet 168. Typically, preferably the extending direction of the first magnetization polarization line 162m is shifted by 90° with respect to the extending direction of the second magnetization polarization line 164m and the extending direction of the third magnetization polarization line 166m is shifted by 90° with respect to the extending direction of the fourth magnetization polarization line 168m. Thus, the frictional resistance when the movable body 120 swings about the first swing axis Sa1 and the second swing axis Sa2 can be further reduced.

Preferably at least one coil is opposite to each of three magnets of the first magnet 162, the second magnet 164, the third magnet 166, and the fourth magnet 168. In this case, the first magnet 162, the second magnet 164, and the third magnet 166 are opposite to the coil 152b, the coil 154b, and the coil 156b, respectively.

The extending direction of the second magnetization polarization line 164m of the second magnet 164 in the three magnets (first magnet 162, second magnet 164, and third magnet 166) is parallel to the optical axis P of the optical element 130, and the extending directions of the remaining first magnetization polarization line 162m of the first magnet 162 and the third magnetization polarization line 166m of the third magnet 166 are orthogonal to the optical axis P. Thus, the movable body 120 can swing along the three swing axes (first swing axis Sa1, second swing axis Sa2, and third swing axis Sa3).

As illustrated in FIG. 14, the first magnetic body 170a further includes a fourth magnetic body portion 174 and a fifth magnetic body portion 175 in addition to the first magnetic body portion 171, the second magnetic body portion 172, and the third magnetic body portion 173. In the first magnetic body 170a, the first magnetic body portion 171, the second magnetic body portion 172, the third magnetic body portion 173, the fourth magnetic body portion 174, and the fifth magnetic body portion 175 are arranged in a cross shape spaced apart from one another.

The fourth magnetic body portion 174 is disposed on one side in the second swing direction Db of the first magnetic body portion 171. In this case, the fourth magnetic body portion 174 is disposed on the −Y-direction side of the first magnetic body portion 171. Accordingly, when the movable body 120 is swung to one side in the second swing direction Db, the fourth magnetic body portion 174 can generate the adsorption force as an aid. As a result, the driving resistance can be reduced when the movable body 120 is swung to one side in the second swing direction Db.

The fifth magnetic body portion 175 is disposed on the other side in the second swing direction Db of the first magnetic body portion 171. In this case, the fifth magnetic body portion 175 is disposed on the +Y-direction side of the first magnetic body portion 171. Accordingly, when the movable body 120 is swung to the other side in the second swing direction Db, the fifth magnetic body portion 175 can generate the adsorption force as an aid. As a result, the driving resistance can be reduced when the movable body 120 is swung to the other side in the second swing direction Db.

In this manner, the magnetic body is disposed along the second swing direction Db. Accordingly, even when the movable body 120 is swung in the second swing direction Db by the first magnetic body 170a, the driving resistance can be reduced.

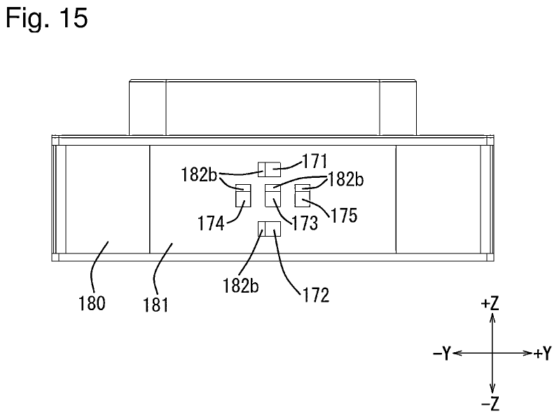

As illustrated in FIG. 14, when the first magnetic body 170a further includes the fourth magnetic body portion 174 and the fifth magnetic body portion 175 in addition to the first magnetic body portion 171, the second magnetic body portion 172, and the third magnetic body portion 173, for example, the reinforcing plate 181 preferably has a shape as illustrated in FIG. 15.

In FIG. 15, five depressions 182 of the reinforcing plate 181 are rectangular through-holes that are disposed substantially in a cross shape and penetrate in the X-direction. The first magnetic body portion 171, the second magnetic body portion 172, the third magnetic body portion 173, the fourth magnetic body portion 174, and the fifth magnetic body portion 175 are in contact with the peripheral surface 182a of the depression 182 with three sides interposed therebetween. At this time, the gap 182b is generated on the −Z-side between the first magnetic body portion 171, the fourth magnetic body portion 174, and the fifth magnetic body portion 175 and the peripheral surface 182a. The gap 182b is generated on the −Y-side between the second magnetic body portion 172 and the third magnetic body portion 173 and the peripheral surface 182a. The adhesive portion 183 can be inserted into each gap 182b.

As illustrated in FIG. 14, the second magnetic body 170b includes the first magnetic body portion 171, the second magnetic body portion 172, the third magnetic body portion 173, the fourth magnetic body portion 174, and the fifth magnetic body portion 175.

The first magnetic body portion 171 of the second magnetic body 170b passes through the axis AX1 perpendicular to each of the second swing axis Sa2 and the optical axis P of the optical element 130. The first magnetic body portion 171 of the second magnetic body 170b is opposite to the second magnet 164. Accordingly, the movable body 120 can be held at an initial position.

The second magnetic body portion 172 of the second magnetic body 170b is disposed on one side in the second swing direction Db with respect to the first magnetic body portion 171 of the second magnetic body 170b. In this case, the second magnetic body portion 172 of the second magnetic body 170b is disposed on the +Y-direction side with respect to the first magnetic body portion 171 of the second magnetic body 170b. Accordingly, when the movable body 120 is swung to one side in the second swing direction Db, the second magnetic body portion 172 of the second magnetic body 170b can generate the adsorption force as an aid. As a result, the driving resistance can be reduced.

The third magnetic body portion 173 of the second magnetic body 170b is disposed on the other side in the second swing direction Db with respect to the first magnetic body portion 171 of the second magnetic body 170b. In this case, the third magnetic body portion 173 of the second magnetic body 170b is disposed on the −Y-direction side of the first magnetic body portion 171. Accordingly, when the movable body 120 is swung to the other side in the second swing direction Db, the third magnetic body portion 173 of the second magnetic body 170b can generate the absorption force as an aid. As a result, the driving resistance can be reduced.

As illustrated in FIG. 14, when the second magnetic body 170b further includes the fourth magnetic body portion 174 and the fifth magnetic body portion 175 in addition to the first magnetic body portion 171, the second magnetic body portion 172, and the third magnetic body portion 173, for example, the reinforcing plate 181 has the same shape as that illustrated in FIG. 15. In FIG. 15 describing the reinforcing plate 181 for the first magnetic body 170a, the reinforcing plate 181 is attached to the fixed body 110 on the +X-direction side. The reinforcing plate 181 for the second magnetic body 170b is different from the fixed body 110 only in that the reinforcing plate 181 is attached to the −X-direction side.

The five depressions 182 of the reinforcing plate 181 for the second magnetic body 170b are rectangular through-holes that are disposed substantially in the cross shape and penetrate in the X-direction. The first magnetic body portion 171, the second magnetic body portion 172, the third magnetic body portion 173, the fourth magnetic body portion 174, and the fifth magnetic body portion 175 are in contact with the peripheral surface 182a of the depression 182 with three sides interposed therebetween. At this time, the gap 182b is generated on the −Z-side between the first magnetic body portion 171, the fourth magnetic body portion 174, and the fifth magnetic body portion 175 and the peripheral surface 182a. The gap 182b is generated on the +Y-side between the second magnetic body portion 172 and the third magnetic body portion 173 and the peripheral surface 182a. The adhesive portion 183 can be inserted into each gap 182b.

Additionally, as illustrated in FIG. 14, the third magnetic body 170c includes the first magnetic body portion 171, the second magnetic body portion 172, the third magnetic body portion 173, the fourth magnetic body portion 174, and the fifth magnetic body portion 175.

The first magnetic body portion 171 of the third magnetic body 170c passes through the axis AX2 perpendicular to each of the third swing axis Sa3 and the optical axis P of the optical element 130. The first magnetic body portion 171 of the third magnetic body 170c is opposite to the third magnet 166. Accordingly, the movable body 120 can be held at an initial position.

The second magnetic body portion 172 of the third magnetic body 170c is disposed on one side in the third swing direction Dc with respect to the first magnetic body portion 171 of the third magnetic body 170c. In this case, the second magnetic body portion 172 of the third magnetic body 170c is disposed on the +Z-direction side with respect to the first magnetic body portion 171 of the third magnetic body 170c. Accordingly, when the movable body 120 is swung to one side in the third swing direction Dc, the second magnetic body portion 172 of the third magnetic body 170c can generate the adsorption force as an aid. As a result, the driving resistance can be reduced when swinging the movable body 120 to one side in the third swing direction Dc.

The third magnetic body portion 173 of the third magnetic body 170c is disposed on the other side in the third swing direction Dc with respect to the first magnetic body portion 171 of the third magnetic body 170c. In this case, the third magnetic body portion 173 of the third magnetic body 170c is disposed on the −Y-direction side of the first magnetic body portion 171 of the third magnetic body 170c. Accordingly, when the movable body 120 is swung to the other side in the third swing direction Dc, the third magnetic body portion 173 of the third magnetic body 170c can generate the adsorption force as an aid. As a result, the driving resistance can be reduced when swinging the movable body 120 to the other side in the third swing direction Dc.

As illustrated in FIG. 14, when the third magnetic body 170c further includes the fourth magnetic body portion 174 and the fifth magnetic body portion 175 in addition to the first magnetic body portion 171, the second magnetic body portion 172, and the third magnetic body portion 173, for example, the reinforcing plate 181 has the same shape as that illustrated in FIG. 15. In FIG. 15 describing the reinforcing plate 181 for the first magnetic body 170a, the reinforcing plate 181 is attached to the fixed body 110 on the +X-direction side. The reinforcing plate 181 for the third magnetic body 170c is different from the fixed body 110 only in that the reinforcing plate 181 is attached to the −Y-direction side.

The five depressions 182 of the reinforcing plate 181 for the third magnetic body 170c are rectangular through-holes that are disposed substantially in the cross shape and penetrate in the X-direction. The first magnetic body portion 171, the second magnetic body portion 172, the third magnetic body portion 173, the fourth magnetic body portion 174, and the fifth magnetic body portion 175 are in contact with the peripheral surface 182a of the depression 182 with three sides interposed therebetween. At this time, the gap 182b is generated on the −Z-side between the first magnetic body portion 171, the fourth magnetic body portion 174, and the fifth magnetic body portion 175 and the peripheral surface 182a. The gap 182b is generated on the −X-side between the second magnetic body portion 172 and the third magnetic body portion 173 and the peripheral surface 182a. The adhesive portion 183 can be inserted into each gap 182b.

As described above, in the first magnetic body 170a, the magnetic body is disposed along the first swing direction Da. In the second magnetic body 170b, the magnetic body is disposed along the second swing direction Db. In the third magnetic body 170c, the magnetic body is disposed along the third swing direction Dc. Accordingly, the driving resistance can be reduced when swinging the movable body 120 in the triaxial direction.

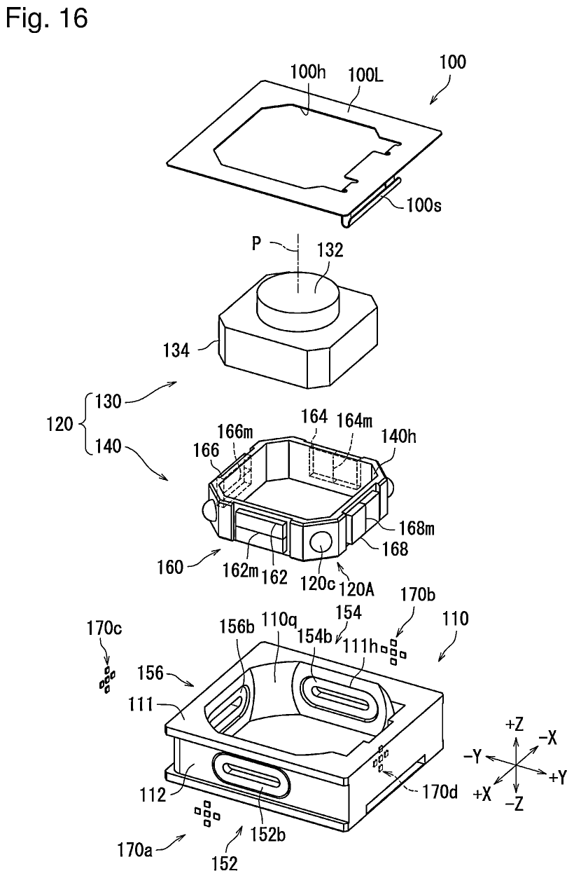

with reference to FIGS. 14 and 16, a configuration of the optical assembly 100 in the modification of the example embodiment of the present disclosure will be described below. FIG. 16 is a schematic exploded perspective view illustrating the optical assembly 100 in the modification of the example embodiment of the present disclosure. In FIG. 16, the FPC 180 is omitted.

As illustrated in FIG. 16, the magnet 160 includes the first magnet 162, the second magnet 164, the third magnet 166, and the fourth magnet 168. In this case, the magnet 160 is attached to the outer peripheral surface of the holder 140. The first magnet 162 is located on the +X-direction side of the holder 140. The second magnet 164 is located on the −X-direction side of the holder 140. The third magnet 166 is located on the −Y-direction side of the holder 140. The fourth magnet 168 is located on the +Y-direction side of the holder 140.

The optical assembly 100 includes the first magnetic body 170a, the second magnetic body 170b, the third magnetic body 170c, and the fourth magnetic body 170d. In this case, the first magnetic body 170a, the second magnetic body 170b, the third magnetic body 170c, and the fourth magnetic body 170d are attached to the fixed body 110 or the FPC 180. The first magnetic body 170a is located on the +X-direction side of the FPC 180. The second magnetic body 170b is located on the −X-direction side of the FPC 180. The third magnetic body 170c is located on the −Y-direction side of the FPC 180. The fourth magnetic body 170d is located on the +Y-direction side of the inner surface of the fixed body 110.

The first swing mechanism 152 includes the first magnet 162 and the coil 152b opposite to the first magnet 162. The first magnet 162 and the coil 152b are located on the +X-direction side of the movable body 120.

The second swing mechanism 154 includes the second magnet 164 and the coil 154b opposite to the second magnet 164. The second magnet 164 and the coil 154b are located on the −X-direction side of the movable body 120.

The third swing mechanism 156 includes the third magnet 166 and the coil 156b opposite to the first magnet 162. The third magnet 166 and the coil 156b are located on the −Y-direction side of the movable body 120.

For example, the correction of the pitching, the yawing, and the rolling of the movable body 120 are performed as follows. When the shake in at least one of the pitching direction, the yawing direction, and the rolling direction is generated in the optical assembly 100, the shake is detected by a magnetic sensor (Hall element) (not illustrated), and based on the result, the first swing mechanism 152, the second swing mechanism 154, and the third swing mechanism 156 are driven to swing the movable body 120. The shake of the optical assembly 100 may be detected using a shake detection sensor (gyroscope) or the like. Based on the detection result of the shake, the current is supplied to the coil 152b, the coil 154b, and the coil 156b to correct the shake.

In the first magnetic body 170a described with reference to FIG. 14, the first magnetic body portion 171, the second magnetic body portion 172, the third magnetic body portion 173, the fourth magnetic body portion 174, and the fifth magnetic body portion 175 are arranged in the cross shape spaced apart from one another. However, the present example embodiment is not limited thereto. The fourth magnetic body portion 174 and the fifth magnetic body portion 175 may be connected to the first magnetic body portion 171.

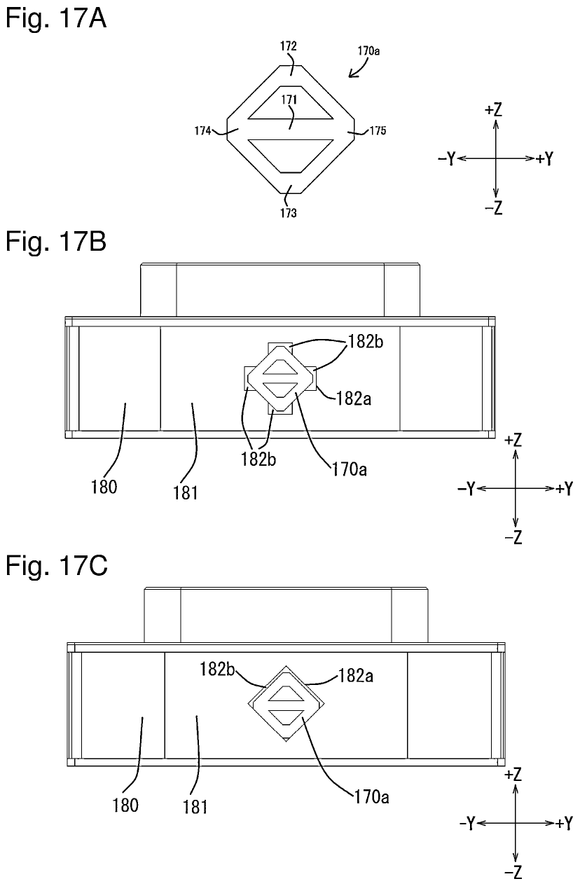

With reference to FIG. 17A, a modification of the first magnetic body 170a will be described.

As illustrated in FIG. 17A, the first magnetic body 170a includes the first magnetic body portion 171, the second magnetic body portion 172, the third magnetic body portion 173, the fourth magnetic body portion 174, and the fifth magnetic body portion 175.

The first magnetic body portion 171 and the second magnetic body portion 172 are spaced apart from each other. The first magnetic body portion 171 and the third magnetic body portion 173 are spaced apart from each other. The first magnetic body portion 171 is connected to the fourth magnetic body portion 174. The first magnetic body portion 171 is connected to the fifth magnetic body portion 175. The second magnetic body portion 172 is connected to the fourth magnetic body portion 174 and the fifth magnetic body portion 175. The third magnetic body portion 173 is connected to the fourth magnetic body portion 174 and the fifth magnetic body portion 175. Accordingly, in the first magnetic body 170a, the first magnetic body portion 171, the second magnetic body portion 172, the third magnetic body portion 173, the fourth magnetic body portion 174, and the fifth magnetic body portion 175 are coupled. As a result, the number of components can be reduced.

At this time, for example, the reinforcing plate 181 is preferably shaped as illustrated in FIGS. 17B and 17C. In this case, the reinforcing plate 181 attached to the fixed body 110 on the +X-direction side will be described as an example.

In FIG. 17B, the depression 182 of the reinforcing plate 181 has a cross shape. The first magnetic body 170a is in contact with the peripheral surface 182a at four sides. At this time, the first magnetic body 170a is positioned by the reinforcing plate 181 on one side and the other side in the Y-direction. In addition, the first magnetic body 170a is positioned by the reinforcing plate 181 also on one side and the other side in the Z-direction. At this time, the gap 182 is generated on one side and the other side in the Y-direction with respect to the first magnetic body 170a, and generated on one side and the other side in the Z-direction. The adhesive portion 183 can be inserted into these four gaps 182.

In FIG. 17C, the depression 182 of the reinforcing plate 181 has a rhombic shape slightly larger than the first magnetic body 170a. The first magnetic body 170a is in contact with the peripheral surface 182a at two sides on the −Z-side. At this time, the adhesive portion 183 can be inserted between the two sides on the +Z-side of the first magnetic body 170a and the peripheral surface 182a.

The modification of the first magnetic body 170a described above is also applicable to the second magnetic body 170b, the third magnetic body 170c, and the fourth magnetic body 170d. In this case, for example, the reinforcing plates 181 for the second magnetic body 170b and the third magnetic body 170c have the same shapes as those illustrated in FIGS. 17B and 17C. The reinforcing plate 181 for the second magnetic body 170b is different from the fixed body 110 only in that the reinforcing plate 181 is attached to the −X-direction side. The reinforcing plate 181 for the third magnetic body 170c is different from the fixed body 110 only in that the reinforcing plate 181 is attached to the −Y-direction side.

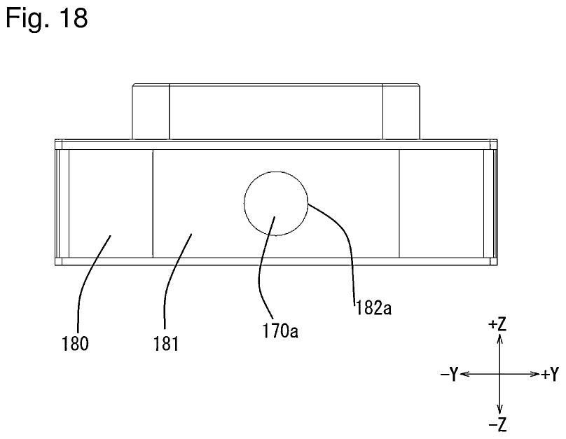

In the above description with reference to FIGS. 2 to 17, the first magnetic body 170a is the rectangular plate member, but the present disclosure is not limited thereto. As illustrated in FIG. 18, the first magnetic body 170a may be a circular plate member.

In the optical assembly including at least two magnetic bodies, the disposition of the magnetic body portions may be different for each magnetic body, and the shape of the reinforcing plate 181 may be different for each magnetic body. On the other hand, the disposition of the magnetic body portions and the shape of the reinforcing plate 181 may be the same in all the magnetic bodies.

In the above description, the optical element 130 includes the lens 132 and the housing 134, but is not limited thereto. The present disclosure is also applicable to a configuration in which the shake correction is performed by driving a single lens, an imaging element, or a prism.

The example embodiment of the present disclosure have been described above with reference to the drawings (FIGS. 1 to 18). However, the present disclosure is not limited to the above-described example embodiment, and can be implemented in various modes without departing from a gist thereof. For easy understanding, the drawings schematically illustrate each constituent element as the subject, and the thickness, length, number, and the like of each illustrated constituent element are different from actual ones for convenience of drawing. The material, shape, dimensions, and the like of each component described in the above example embodiment are merely examples and are not particularly limited, and various modifications can be made without substantially departing from the effects of the present disclosure.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An optical assembly comprising:
a movable body including an optical element;
a fixed body that is located around the movable body and swingably supports the movable body; and
a swing mechanism that causes the movable body to swing about a swing axis with respect to the fixed body; wherein
the swing mechanism is located in a first direction orthogonal to the swing axis;
the swing mechanism includes:
a magnet located on the movable body; and
a coil located on the fixed body;
the fixed body includes:
a circuit board that is located on one side in the first direction of the fixed body and electrically connected to the coil;
a reinforcing plate that is located on the circuit board and includes a depression depressed toward another side in the first direction; and
a magnetic body that is located in the depression and overlaps the magnet;
the depression includes a peripheral surface perpendicular to the first direction; and
the magnetic body is in contact with the peripheral surface of the depression in at least two locations.

2. The optical assembly according to claim 1, wherein the depression is a through-hole penetrating the reinforcing plate.

3. The optical assembly according to claim 1, further comprising an adhesive portion that adheres the magnetic body to at least one of the reinforcing plate and the circuit board.

4. The optical assembly according to claim 3, wherein at least a portion of the adhesive portion is located on one side in the first direction with respect to the magnetic body.

5. The optical assembly according to claim 1, wherein the depression is a closed space located inside the reinforcing plate when viewed from the first direction.

6. The optical assembly according to claim 3, wherein when viewed from the first direction, a gap separating the reinforcing plate and the magnetic body is provided, and at least a portion of the adhesive portion is located in the gap and is in contact with each of the reinforcing plate and the magnetic body.

7. The optical assembly according to claim 1, wherein a length in the first direction of the depression is longer than a length in the first direction of the magnetic body.

8. The optical assembly according to claim 1, wherein the fixed body includes a step protruding in the first direction, and the circuit board is located along the step.

9. The optical assembly according to claim 8, wherein the step extends along any two directions in directions perpendicular to the first direction.

10. The optical assembly according to claim 1, wherein the magnetic body is in contact with the reinforcing plate on one side and another side in a direction perpendicular to the first direction.
